(19) United States
(12) Patent Application Publication
(10) Pub. No.: US 2021/0033340 A1
(43) Pub. Date: Feb. 4, 2021

(54) HEATING DEVICE

(71) Applicant: KRAUSSMAFFEI TECHNOLOGIES GMBH, München (DE)

(72) Inventor: Stefan Schierl, Germering (DE)

(21) Appl. No.: 17/042,631

(22) PCT Filed: Apr. 11, 2019
(86) PCT No.: PCT/EP2019/059263

§ 371 Date: Sep. 28, 2020

(30) Foreign Application Priority Data
Apr. 25, 2018 (DE) 10 2018 109 945.2

(51) Int. Cl. F27B 9/36; B29B 13/02; B32B 37/06; F27D 5/00

(52) U.S. Cl. CPC F27B 9/36; B29B 13/023; B29C 2045/14877; F27D 5/0006; B32B 37/06

(57) ABSTRACT

A heating device with an oven into which a semi-finished product to be heated can be moved in and out, with a wire support formed from several wires spaced apart from one another, and on which the semi-finished product is able to be positioned, and with structure for moving the wire support into the oven and out therefrom. In order to both enable a method with high speeds of travel and at the same time able to use one and the same wire support for differently shaped semi-finished products. The wires can be electrically conductive and the selected wires can be acted upon with a voltage and thereby be heated, wherein the voltage is able to be set and/or controlled in such a way that the wires can adopt a predefinable temperature. Through suitable heating of the wires, the semi-finished product can be fixed on the wire support by fusing.

The invention relates to a heating device according to the introductory clause of Claim 1, an injection moulding system equipped with such a heating device, and a method for producing plastic moulded parts from a semi-finished product which is overmoulded with a plastic material.

A generic heating device is known from DE102014010173A1. This heating device is usually used in injection moulding systems in order to produce plastic moulded parts which consist of a semi-finished product which is overmoulded with plastic material. The heating device known from DE102014010173A1 has a carriage system by which a frame can be moved through a heating region formed by radiant heaters.

According to a first embodiment (DE102014010173A1, FIG. 4), a clamping frame is provided with several spring-loaded holding devices formed as clamps. The semi-finished product is held in its position by means of the clamps. The clamps are spring-loaded, in order to compensate for thermal deformations of the semi-finished product and the thermal expansion of the clamping frame. According to a second embodiment (DE102014010173A1, FIG. 5) a wire support formed from several wires is clamped into the frame, wherein the wires are spring-loaded for the compensation of thermal deformations. In this case, the semi-finished product is only deposited on the wire support.

Basically, it is regarded as advantageous if during the movement of the wire support a slipping of the semi-finished product can be prevented. In the example embodiment according to FIG. 5 of DE102014010173A1, in which the semi-finished product only rests on the wire support, therefore only small speeds of travel can be set. The situation is different in the example embodiment of FIG. 4 in DE102014010173A1, where spring-loaded clamps are used as positioning aid and for holding the semi-finished product. With this embodiment, higher speeds of travel can also be provided. A disadvantage herein, however, is that these positioning aids must be adapted respectively individually for differently configured semi-finished products. When such positioning aids consist of a metallic material, these heat up, which involves some disadvantages. On the one hand, changes in the position of the semi-finished product can occur in the oven, and on the other hand the heating-up behaviour of the semi-finished product can be negatively influenced through the thermal capacity of the positioning aid.

Proceeding herefrom, the invention is based on the problem of indicating a heating device which is able to be used for differentially shaped semi-finished products, without adaptations to the wire support having to be carried out.

The solution to this problem takes place through a heating device having the features of Claim 1. Advantageous configurations and further developments are to be found in the dependent claims.

Through the fact that the wires of the wire support are electrically conductive and that selected wires are acted upon with a voltage and can thereby be heated, wherein the voltage is able to be set and/or able to be regulated in such a way that the wires can assume a predefinable temperature, the surface of the semi-finished product can be heated above the melting temperature of the matrix of the semi-finished product. This leads to a bonding of the semi-finished product with the wire support, whereby a positioning aid is superfluous. The position, once adopted, is not left any more on depositing of the semi-finished product on the wire base. Also in the case of comparatively high speeds of travel, the semi-finished product remains lying securely in its position on the wire support.

A further advantage lies in that one and the same wire support is able to be used for differently shaped semi-finished products, as long as the semi-finished product is smaller than the available support area of the wire support. Thereby, one and the same wire support can be used for differently contoured semi-finished products. In the case of a change of the semi-finished product, in contrast to the prior art, no adaptations to the wire support are to be carried out. As no positioning aids are present, the disadvantages connected with these, as have been mentioned above, are also eliminated.

According to a first embodiment, the wire support can be formed from several wires lying parallel to one another. Furthermore, it is possible that the wire support is formed from several wires crossing each other, wherein the wires preferably cross each other at an angle of 90°. A suitable insulation can be provided at the crossing points.

Preferably, a temperature sensor is provided at one or more of the wires, in order to measure the temperature of this wire and to be able to set a suitable temperature for the semi-finished product.

In further development of the invention, a carriage can be provided for moving the wire support, which carriage can be moved on a rail system into the oven and out from the latter. The oven and the carriage system can be configured here in the manner as is the case in DE102014010173A1, i.e. the rail system extends through the oven in such a way that a carriage with a wire support on the one side can be moved into the oven and on the opposite side can be moved out from the oven. The oven and the carriage system can, however, also be configured in such a manner that the carriage with the wire support can be moved on one and the same side of the oven into the latter and out therefrom again.

Furthermore, a control device can be provided, by which the voltage is adjustable and/or controllable in such a way that the wires can maintain a predefinable temperature. Thereby, external influences which could lead to temperature fluctuations can be compensated.

A preferred field of application of the heating device according to the invention is a system for the production of plastic moulded parts from a semi-finished product, which is overmoulded with a plastic material. The system comprises an injection moulding machine, known per se, with a clamping unit and with an injection unit, a robot and a heating device according to the invention.

The invention relates in addition to a method for the production of plastic moulded parts from a semi-finished product, which is overmoulded with a plastic material, wherein the semi-finished product is heated by means of a heating device according to the invention, wherein the voltage of the wires is set to a value at which the wires assume a temperature which bring about a melting of the semi-finished product, wherein the heated semi-finished product is removed from the wire support after moving of the wire support out from the oven, and is overmoulded with a plastic material in an injection moulding machine. Robots, known per se, can be used for handling the semi-finished product.

Preferably, steps can be taken in order to set the temperature of the wires in a suitable manner, namely:
Preheating of the wires to a temperature above the melting temperature of the semi-finished product. For a polyamide semi-finished product for example 260° C.
The controlling of the temperature of the wire grid takes place here via at least one thermal element, which is/are fastened on one or respectively in each case on one wire. Preferably, thermal elements with small dimensions are to be used for this, in order to keep the thermal mass as small as possible.
Together with a suitable switching element such as a solid state relay (SSR), the temperature increase of the wire can now be controlled over the duration of the application with electrical voltage, wherein the temperature is measured with the thermal element. It is likewise conceivable to adapt the voltage or the current intensity accordingly, instead of the switch-on duration.
A temperature control via the switch-on duration is already known for example in the temperature control of ceramic heating bands or infrared emitters, and prior art
Therefore, at the time of the placing of the semi-finished product onto the oven grid, a wire support is present which is temperature-controlled above the melting temperature
Through the contact between semi-finished product and wire support, a heat transfer results from the wire support to the semi-finished product, and the semi-finished product, or respectively the matrix material contained in the semi-finished product, melts
Due to the melting process, a form fit results between the placed semi-finished product and the wire support.
This form fit leads to a reliable fixing of the semi-finished product on the wire support and enables a quick movement of travel of the wire support without displacement of the semi-finished product on the oven grid.

In accordance with the present invention, in particular so-called organic sheets or fibre-plastic composite inserts are to be regarded as semi-finished product. Furthermore, the following products can be regarded as semi-finished products in accordance with the present invention:

natural fibre semi-finished products
non-woven materials
all flat semi-finished products consisting of fibres and of thermoplastic or thermosetting matrix.

Typical fibre-matrix combinations are:
glass fibre fabric with polypropylene or polyamide
carbon fibre fabric with polyamide
unidirectional (UD) layer structures with polyamide or polypropylene
natural fibre-polypropylene non-woven materials

The invention is to be described further below with the aid of example embodiments and with reference to the figures. There are shown:

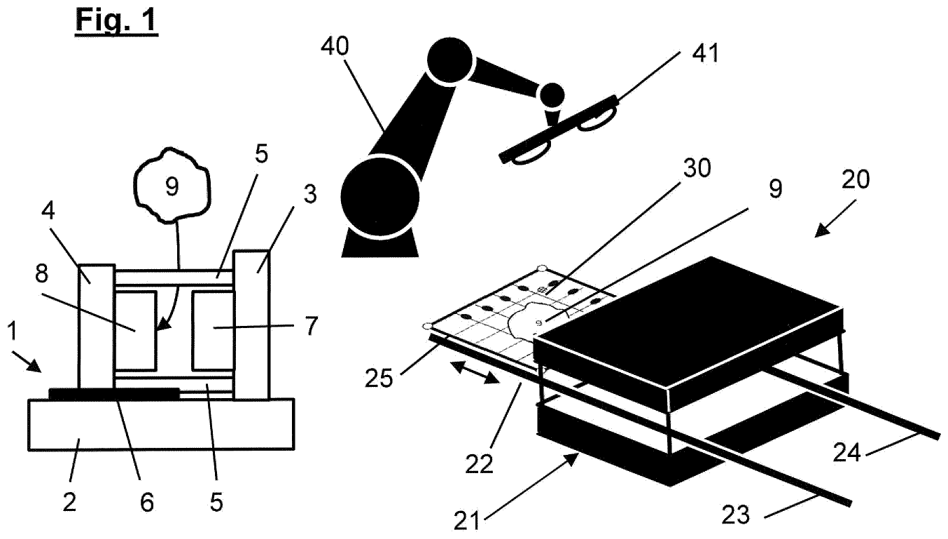

FIG. 1 injection moulding system with a heating device according to the invention

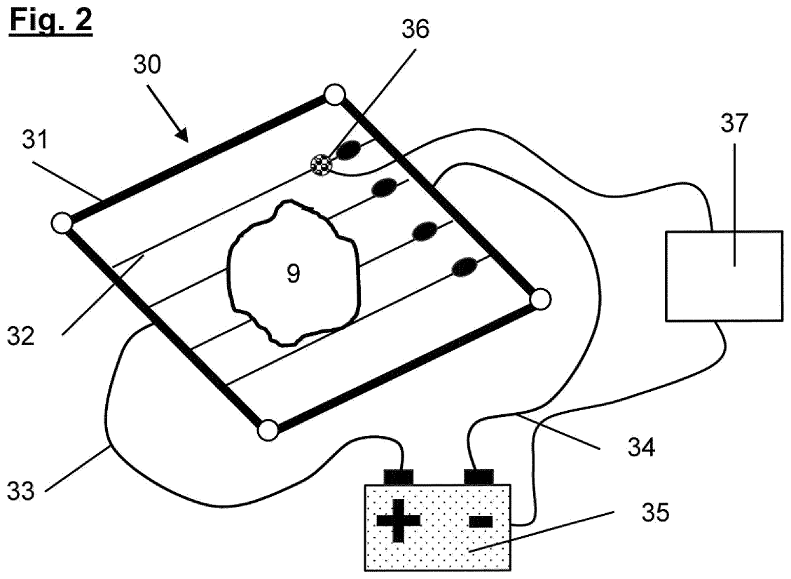

FIG. 2 wire support with parallel wires;

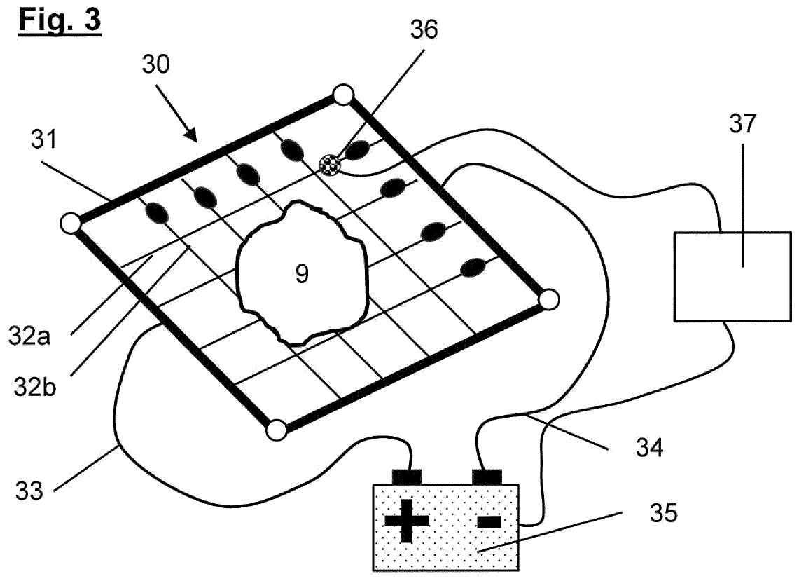

FIG. 3 wire support with crossed wires.

In FIG. 1 an exemplary injection moulding machine 1 is illustrated. The injection moulding machine 1 has a machine bed 2. On the machine bed 2 a fixed platen 3 is secured and a movable platen 4 is mounted in a linearly displaceable manner. For its linearly displaceable mounting, the movable platen 4 is displaceably mounted along four horizontal columns 5. The movable platen 4 can be moved for example by hydraulic drives, not illustrated in further detail, along the longitudinal extent of the four horizontal columns 5. The movable platen 4 is mounted by linear guides 6 in a horizontally movable manner on the machine bed 2. The above-mentioned components of the injection moulding machine form together the so-called clamping unit. A first injection mould half 7 is fastened on the fixed platen 3. A second injection mould half 8 is fastened on the movable platen 4. In the present example embodiment, the two injection mould halves 7 and 8 are configured to be able to form an organic sheet 9 and to overmould it with thermoplastic material. The organic sheet 9 can be a plate-shaped organic sheet 9, for example. For better clarity, an injection unit, which is usually situated to the right of the fixed platen 3, is not illustrated.

In FIG. 1 to the right of the injection moulding machine 1 a heating device according to the invention is illustrated, characterized as a whole by reference number 20. This comprises essentially an oven 21, a carriage system 22 with rails 23, 24, and a carriage 25. A wire support 30 according to the invention can become fastened or be fastened on the carriage. More detailed explanations regarding the wire support 30 are to be found further below in the description of FIGS. 2 and 3. An organic sheet 9 or a different semi-finished product can be deposited on the wire support 30. The carriage 25 can be moved by means of suitable drive means into the oven 30 and out therefrom again. In this way, the organic sheet 9 can be moved into the oven, heated therein, and subsequently moved out from the oven again. This travel movement is to be indicated by the double arrow.

Between the heating device 20 and the injection moulding machine 1, a robot 40 is arranged which is configured for the handling of the organic sheets 9 and in particular has a suitable gripping device 41. By means of the robot 40, an organic sheet 9 which is to be heated can be removed from a storage stack—not illustrated here—and placed onto an empty wire support 30. After the organic sheet 9 has been heated and moved out from the oven 20 again, the heated organic sheet 9 can be brought by means of the same robot 40 into the space between the open mould halves 7 and 8 and fixed there in its position for an injection moulding process. Of course, several robots, also several different robots, can be provided in order to accomplish the handling of the stored organic sheets, of the heated organic sheets and of the finished plastic moulded parts.

FIG. 2 shows a first embodiment of a wire support 30 according to the invention. Several wires 32 are clamped in a frame 31, arranged parallel to one another and at an equal distance from one another. An organic sheet 9 is laid centrally on the wire support 30. The wires 32 are connected to a voltage source 35 via connecting cables 33 and 34. In FIG. 2, for the sake of simplicity, the voltage source 35 is illustrated as a separate battery. Of course, any other suitable voltage source can also be provided, which is suitable to act upon the wires 32 with a suitable voltage for this and to heat them with the effect of resistance heating. Preferably, a temperature sensor 36 is provided at one or more of the wires 32, the values of which temperature sensor can be evaluated by a controller 37, so that the voltage source 35 can be operated in a suitable manner. The controller 37 or respectively the control device 37 preferably serves for the voltage to be adjustable and/or controllable in such a way that the wires 32 maintain a predefinable temperature.

Steps can be taken in order to set the temperature of the wires 32 in a suitable manner, namely:
Preheating the wires to a temperature above the melting temperature of the organic sheet. For a polyamide organic sheet for example 260° C.
The controlling of the temperature of the wire grid takes place here via at least one thermal element, which is or are fastened on one or respectively on one wire in each case. Preferably, thermal elements with small dimensions are to be used for this, in order to keep the thermal mass as small as possible.
Together with a suitable switching element such as a solid state relay (SSR), the temperature increase can now be measured and controlled via the duration of the application with electrical voltage. It is likewise conceivable to adapt the voltage or current intensity accordingly.
A temperature control via the switch-on duration is already known for example in the temperature control of ceramic heating bands or infrared emitters, and prior art
Therefore at the time of laying the organic sheet onto the oven grid, a wire support which is temperature-controlled above the melting temperature is present
Through the contact between organic sheet and wire support, a heat transfer results from the wire support to the organic sheet, and the organic sheet, or respectively the matrix material contained in the organic sheet, melts
Due to the melting process, a form fit results between the placed organic sheet and the wire support.

This form fit leads to a reliable fixing of the organic sheet on the wire support and enables a quick movement of travel of the wire support without displacement of the organic sheet on the oven grid.

FIG. 3 shows a second embodiment of a wire support 30 according to the invention. In contrast to FIG. 2, the wire support is formed from several wires 32a and 32b crossing one another, wherein the wires cross one another at an angle of 90°. A suitable insulation is provided at the crossing points.

The wire support 30 according to the invention is used in a method for the production of plastic moulded parts from an organic sheet 9 or from another semi-finished product, which is overmoulded, or respectively is to be overmoulded, with a plastic material. Here, an organic sheet 9 or respectively the semi-finished product is heated by means of a heating device of the type previously described. The voltage of the wires 32 or 32a/32b is set to a value at which the wires adopt a temperature which brings about a fusing of the organic sheet 9. The carriage 25 can therefore be moved at a comparatively high speed of travel into the oven 20 and, after heating of the organic sheet 9, can be moved out therefrom again. After the moving of the wire support 30 or respectively 32a/32b out from the oven 20, the organic sheet 9 is removed from the wire support and is overmoulded with a plastic material in the injection moulding machine 1.

### LIST OF REFERENCE NUMBERS

1 injection moulding machine

2 machine bed

3 fixed platen

4 movable platen

5 horizontal columns

6 linear guides

7 first injection mould half

8 second injection mould half

9 organic sheet

20 heating device

21 oven

22 carriage system

23 rail

24 rail

25 carriage

30 wire support

31 frame

32 wires

32a wires

32b wires

33 connecting cable

34 connecting cable

35 voltage source

36 temperature sensor

37 controller

40 robot

41 gripping device

What is claimed is:

1. A heating device with an oven (21), into which a semi-finished product (9) which is to be heated can be moved and moved out, with a wire support (30), which is formed by several wires (32, 32a, 32b) spaced apart from one another, and on which the semi-finished product (9) is able to be positioned, and with means (22) for moving the wire support (30) into the oven (21) and out therefrom, wherein the wires (32, 32a, 32b) are electrically conductive and that selected wires (32, 32a, 32b) can be acted upon with a voltage and thereby heated, wherein the voltage is able to be set and/or able to be controlled in such a way that the wires (32, 32a, 32b) can adopt a predefinable temperature, or the switch-on duration of the voltage source is predefined.

2. The heating device according to claim 1, wherein the wire support (30) is formed from several wires (32) lying parallel to one another.

3. The heating device according to claim 1, wherein the wire support is formed by several wires (32a, 32b) crossing one another, wherein the wires (32a, 32b) cross one another at an angle of 90°.

4. The heating device according to claim 1, wherein at one or more of the wires (32, 32a, 32b) respectively a temperature sensor (36) is provided.

5. The heating device according to claim 1, wherein for moving the wire support (30) a carriage (25) is provided, which can be moved on a rail system (23, 24) into the oven (21) and out therefrom.

6. The heating device according to claim 1, wherein a control device (37) is provided, by which the voltage is able to be set and/or is able to be controlled in such a way that the wires (32, 32a, 32b) can maintain a predefinable temperature.

7. An injection moulding machine (1) for the production of plastic moulded parts from a semi-finished product (9), which is overmoulded with a plastic material, comprising a clamping unit, an injection unit, a robot and a heating device according to claim 1.

8. A method for the production of plastic moulded parts from a semi-finished product, which is overmoulded with a plastic material, wherein the semi-finished product is heated by means of a heating device according to claim 1, wherein the voltage of the wires is set to a value at which the wires adopt a temperature which bring about a fusing of the semi-finished product, wherein the heated semi-finished product, after the moving out of the wire support from the oven, is removed from the wire support and is overmoulded with a plastic material in an injection moulding machine.
